(19) United States
(12) Patent Application Publication
(10) Pub. No.: US 2003/0067456 A1
(43) Pub. Date: Apr. 10, 2003

(54) Indirect interface

(76) Inventors: Yun Shon Low, Richmond (CA); Barinder Singh Rai, Surrey (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/215,248

(22) Filed: Aug. 8, 2002

Related U.S. Application Data
(60) Provisional application No. 60/328,257, filed on Oct. 9, 2001.

(51) Int. Cl. G09G 5/00

(52) U.S. Cl. 345/204

(57) ABSTRACT

An indirect interface of the present invention is for use between a processing device and a display device, the indirect interface using fewer pins by following a set of predetermined rules. Address and data signals are multiplexed onto an address/data bus of the indirect interface so that a single set of pins can be used as both address line/pins and data line/pins. In one preferred embodiment, a processor interface means transfers signals between the indirect interface system and the external processing device and a display interface means transfers signals between the indirect interface system and the external display device. In one preferred embodiment, the signals may be transferred between the indirect interface system and the external processing device using a command cycle followed by at least one data cycle. In one preferred embodiment, command/data determination signals used to distinguish between the command cycle and the data cycle may be transferred over a predetermined a command/data determination line/pin.

The present application is a nonprovisional of U.S. Provisional Patent Application Serial No. 60/328,257, filed Oct. 9, 2001. The present application is based on and claims priority from this application, the disclosure of which is hereby incorporated herein by reference.

### BACKGROUND OF INVENTION

The present invention is directed to an embedded memory LCD controller or indirect interface that uses fewer pins by following a set of predetermined rules.

Liquid crystal displays (LCDs) have become one of the most common displays in electronic devices because they are thin, light weight, require relatively low power, portable, widely available, and relatively inexpensive to integrate into products as compared to technologies such as cathode ray tubes (CRTs), plasma displays, and Field Emission Displays. These features make the LCD ideal to integrate into physically small products that are decreasing in size due to consumer demand. Exemplary products that are moving toward miniaturization include laptop, portable, and other computers, personal digital assistants (PDAs), cell phones, electronic games, electronic books (“e-books”), digital cameras, digital video cameras, portable VCD/DVD players, and other portable devices. LCDs are also incorporated into a wide variety of everyday devices such as digital clocks, watches, microwave ovens, CD players, MP3 players, and other devices having electronic displays. LCDs are pervasive in that they are found almost everywhere.

Summarily, LCDs include layers of nematic liquid crystal coatings that have molecules that react predictably to electric current. By applying electric current, the molecules react to change the way light passes through the coatings. Appropriately applied electric current, therefore, produces a desired display.

Applying the appropriate electrical current is typically controlled by the central processing unit (CPU) of a computer. The CPU communicates with the LCD using addresses to determine which pixels will receive electrical current (High) or not receive electrical current (Low). A typical CPU requires seventeen (17) address lines/pins, sixteen (16) data lines/pins, and at least five (5) control signals (RnW, NCS, Byte Enables and NWAIT) to communicate with an LCD. The number of address lines increases as the size of the memory and registers increase. (The increase in memory can be used, for example, to improve the resolution or sharpness of a display or for display caching.) This can easily result in the requirement of thirty-eight (38) dedicated lines/pins that are used to communicate with the host interface. Small devices having small displays, however, do not need this many dedicated lines.

Known references directed to LCD controllers attempt to reduce power consumption and otherwise improve LCD controllers. These references, however, merely reflects the state of the art.

For example, U.S. Pat. No. 5,699,075 to Miyamoto sets forth a display driving apparatus particularly suited to a ferroelectric liquid crystal display. The display driving apparatus improves picture quality by smoothly switching a partial writing mode and a refresh driving mode.

Another example is U.S. Pat. No. 6,100,879 to Da Costa (the “Da Costa reference”) sets forth a “smart controller” chip for controlling an active matrix display that has analog circuitry for generating analog reference levels incorporated within the chip. By eliminating the need for external reference circuitry, the complexity of the display system is reduced. The Da Costa device also includes a programmed register, but the register is programmed with digital values that correspond to analog reference levels.

Still another example is U.S. Pat. No. 6,137,465 to Sekine et al. sets forth a drive circuit for driving an active matrix LCD panel. The drive circuit includes a plurality of drive sections corresponding to a number of data lines disposed in the LCD panel.

Other references that discuss this art include U.S. Pat. No. 6,137,466 to Moughanni et al., U.S. Pat. No. 6,201,522 B1 to Erhart et al., U.S. Pat. No. 6,232,940 B1 to Ohno et al., U.S. Pat. No. 6,262,704 B1 to Kurumisawa et al., U.S. Pat. No. 6,297,786 B1 to Kakuta et al., and U.S. Pat. No. 6,300,930 B1 to Mori.

### BRIEF SUMMARY OF THE INVENTION

The present invention is directed to an embedded memory LCD controller or indirect interface for use between a processing device and a display device. The indirect interface LCD controller of the present invention uses fewer pins by following a set of predetermined rules.

Specifically, the present invention is directed to an indirect interface LCD controller in which the address and data signals are multiplexed onto the data bus (address/data bus) so that a single set of pins can be used as both address line/pins and data line/pins.

One preferred embodiment of the indirect interface system of the present invention includes a processor interface means and a display interface means. The processor interface means transfers signals between the indirect interface system and the external processing device. The display interface means transfers signals between the indirect interface system and the external display device. The processor interface means further includes an address/data bus over which both the address signals and the data signals may be transferred.

In one preferred embodiment of the indirect interface system of the present invention, the signals may be transferred between the indirect interface system and the external processing device using a command cycle followed by at least one data cycle.

In one preferred embodiment of the present invention, the processor interface means further includes a command/data determination line/pin over which command/data determination signals may be transferred. The command/data determination signals distinguish between the command cycle and the data cycle.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a simplified block diagram of a prior art LCD controller connecting a CPU to an LCD display.

FIG. 2 is a simplified block diagram of an exemplary indirect interface LCD controller of the present invention connecting a CPU to an LCD display, the indirect interface having a 16-bit configuration and running in Mode 68.

FIG. 3 is a simplified block diagram of an exemplary indirect interface LCD controller of the present invention connecting a CPU to an LCD display, the indirect interface having a 16-bit configuration and running in Mode 80.

FIG. 4 is a simplified block diagram of an exemplary indirect interface LCD controller of the present invention connecting a CPU to an LCD display, the indirect interface having an 8-bit configuration and running in Mode 68.

FIG. 5 is a simplified block diagram of an exemplary indirect interface LCD controller of the present invention connected to an LCD display, a register module and memory module being used functionally therebetween.

FIG. 6 is a simplified operational flow chart of the indirect interface LCD controller of the present invention.

FIG. 7 is an exemplary state machine of the indirect interface LCD controller of the present invention.

FIGS. 8 to 19 are exemplary timing diagrams of preferred embodiments of the present invention, FIGS. 8 to 14 being specifically directed to a preferred embodiment in Mode 68 and FIGS. 15 to 19 being specifically directed to a preferred embodiment in Mode 80.

### DETAILED DESCRIPTION OF THE INVENTION

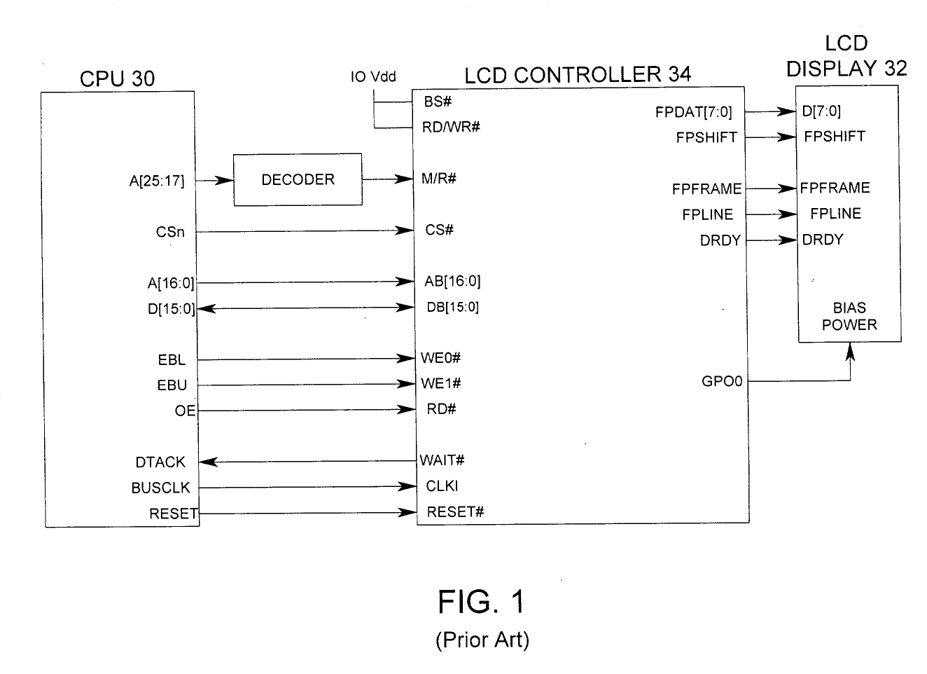

As shown in FIG. 1, a typical CPU 30 requires seventeen (17) address lines/pins, sixteen (16) data lines/pins, and at least five (5) control signals (RnW, NCS, Byte Enables and NWAIT) to communicate with an LCD display 32. A typical LCD controller 34 may be used to provide an interface between the CPU 30 and the LCD display 32. The number of address lines necessary to control the LCD display 32 increases as the size of the memory and registers increase. For complicated LCD displays 32, thirty-eight (38) dedicated lines/pins (or more) may be necessary to communicate with the host interface. Small devices, however, do not need this many dedicated lines.

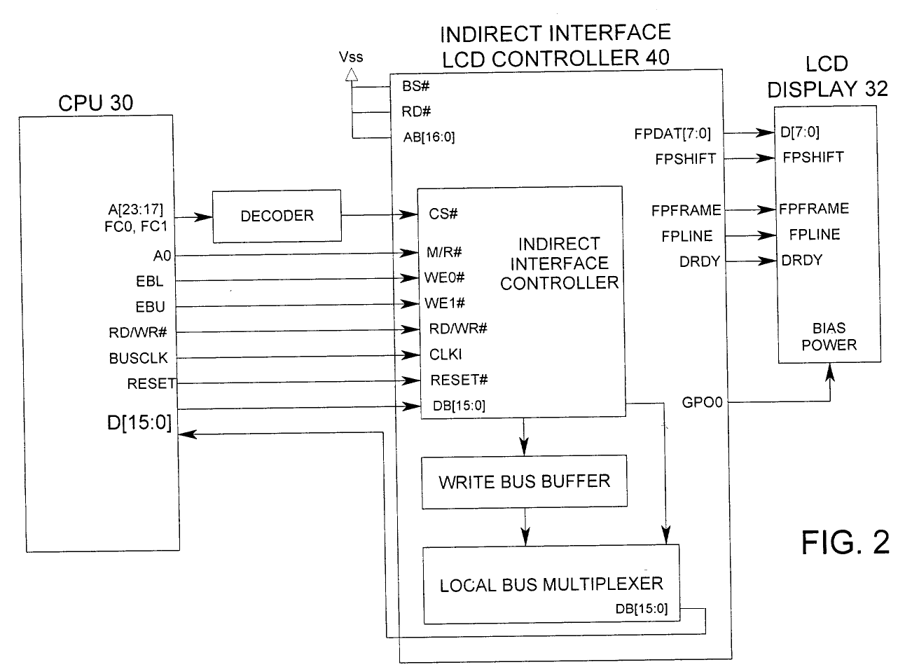

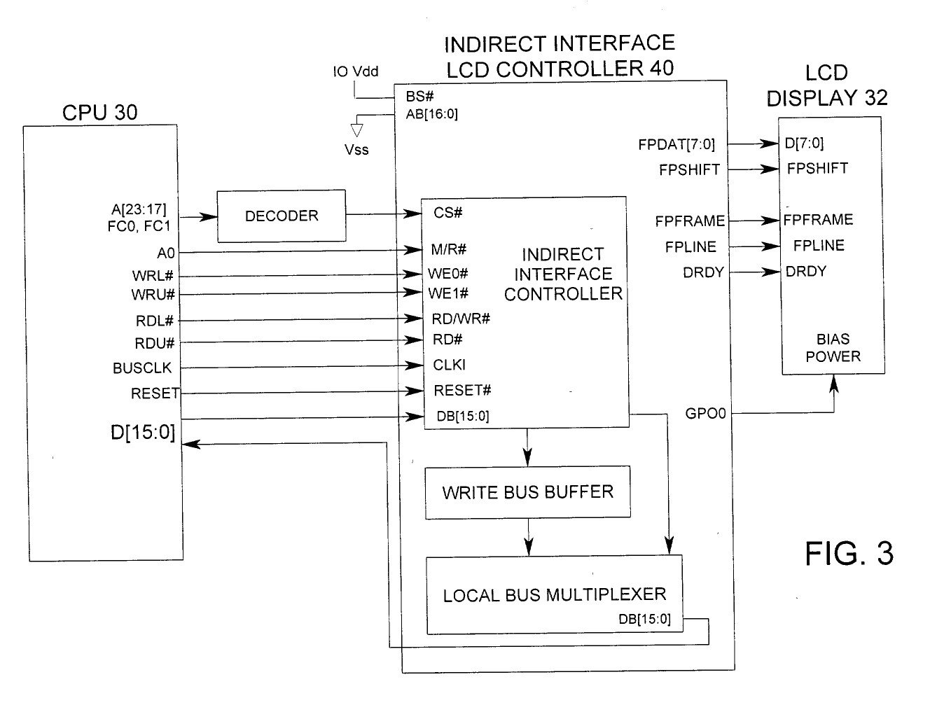

The present invention, as shown in FIGS. 2-5, is directed to an embedded memory display controller 40 (which is shown and described as “indirect interface LCD controller 40”) that acts an indirect interface between the CPU 30 and the LCD display 32. As compared to traditional LCD controllers 34, the indirect interface LCD controller 40 of the present invention reduces the number of pins necessary for connections (thus eliminating excess connections), is smaller (and therefore reduces space requirements), and reduces power consumption of the entire system (not just the LCD controllers). This makes the indirect interface LCD controller 40 particularly attractive for use with physically small devices and microprocessors that cannot provide full direct addressing through an address bus to the indirect interface LCD controller 40. The indirect interface LCD controller 40 of the present invention requires only sixteen (16) data lines/pins and five (5) control signals to access any range of memory and registers. The increase of memory and register size will not increase the number of data lines required. An exemplary embodiment of a 16-bit configuration is shown in FIGS. 2 and 3.

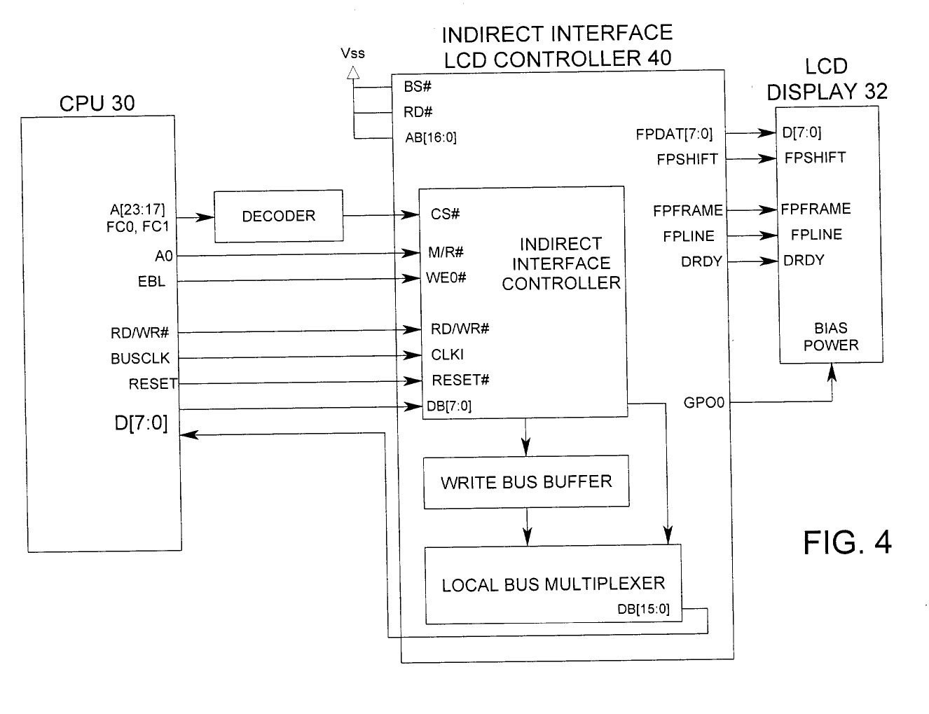

An alternative embodiment of the indirect interface LCD controller 40 of the present invention can be implemented with only eight (8) data lines/pins and four (4) control signals that would further minimize the number of pins required. This reduces the bandwidth by half. For example, with only eight (8) data lines/pins, a data write will only have 8-bit accesses. An exemplary embodiment of an 8-bit configuration is shown in FIG. 4.

The indirect interface LCD controller 40 of the present invention uses fewer pins by following a set of predetermined rules. In one preferred embodiment, the predetermined rules are based on the address and data signals applied to the indirect interface LCD controller 40 being multiplexed onto the data bus so that a single set of pins can be used as both address pins and data line/pins. The data bus is shared between data and address signals. Because the address and data signals are multiplexed onto the data bus, the indirect interface LCD controller 40 does not need the address bus. The CPU provides one command cycle and a data cycle for each access. Further, no address boundary checking is provided in the preferred embodiment of the indirect interface LCD controller 40.

Since the indirect interface LCD controller 40 of the present invention, in one preferred embodiment, has a 17-bit address, a minimum of two accesses (16-bit of addresses transferred for each access) is required to store the memory address before the memory access. For example, two 16-bit register accesses are performed to write the start memory address to three 8-bit registers. Once the memory address is stored, the CPU 30 executes a write command (command cycle) to signal a memory access start in its associated data cycles. A memory burst will continue until a new command cycle is detected or CPU 30 ceases the data cycle.

The exemplary indirect interface LCD controller 40 has two modes of operation, “mode 68” and “mode 80.” The modes are distinguished between one another by the polarity of NBS (narrowband socket). Both modes support 8 and 16 bit accesses for both little and big endian.

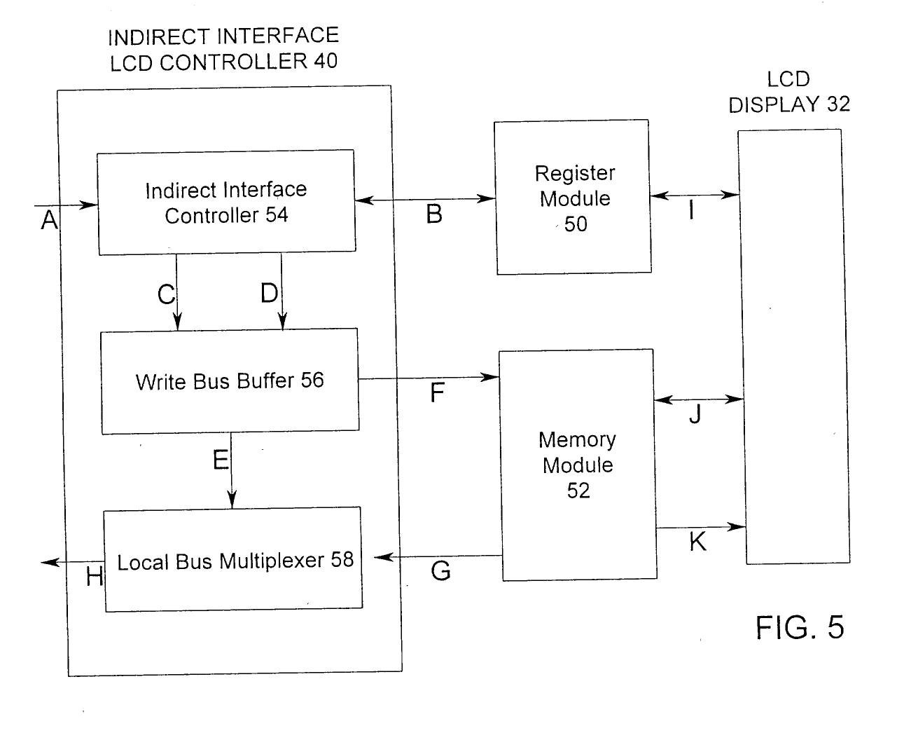

The indirect interface LCD controller 40 has several additional features that may be included. For example, the indirect interface LCD controller 40 preferably has an asynchronous design in which neither the control signals nor the data lines have to be synchronous to a CPU's clock edge. A Burst Mode with Auto Increment of Memory address (both byte and word increments) feature may be included to reduce latency. This also allows for quick refreshing of the display buffer (shown as memory module 52 in FIG. 5) in the LCD controllers. The Auto Increment of Memory Address could also be implemented by having the user write to a memory location by programming REG[C0h] through [C2h].

To implement the indirect interface LCD controller 40 of the present invention, a combination of “command” and “data” reads/writes are used to program the indirect interface LCD controller 40. First, register addresses are loaded using “command” writes. Then, register values and memory reads/writes are performed using “data” reads/writes. Memory addresses are performed by programming memory locations (e.g. REG[C0h] through [C2h]) with the desired 17-bit address. If the Memory Access Select bit is enabled (REG[C6h] bit 0=1), memory accesses are always word accesses and the signals WRU#, RDU# and EBU are ignored (WRL#, RDL# and EBL are used for accessing both the higher and lower bytes). If the Memory Access Select bit is disabled, byte/word accesses to memory are controlled by WRn#, RDn #, and EBn.

After the initial programming, the following rules are used to implement further the indirect interface LCD controller 40:

1. A command cycle is always sent first followed by a data cycle.

2. A0(InMXR) is used to distinguish between command and data cycles.

3. Command write is always the lower byte (i.e. 8 bits).

FIG. 5 shows a simplified exemplary embodiment of the indirect interface LCD controller 40 of the present invention connected to an LCD display 32. A register module 50 and a memory module 52 are functionally interposed therebetween. Although the register module 50 and memory module 52 are shown as independent modules, it should be noted that they might also be incorporated into the CPU 30, the LCD display 32, or the indirect interface LCD controller 40 of the present invention. This figure also shows simplified embodiments of an indirect interface controller 54, a write bus buffer 56, and a local bus multiplexer 58. The main purpose of this figure, however, is to show an exemplary flow of information between the various components. It should be noted that additional signal paths may be possible and that alternative paths to those shown may exist.

The indirect interface controller 54 receives indirect interface commands and input data bus signals A from the CPU 30 and transmits and/or receives requests and acknowledgements B for the register module 50 and a memory module 52. The indirect interface controller 54 sends control signals C and latched register/memory address signals D to the write bus buffer 56.

The write bus buffer 56 functions as a transfer buffer for the host interface to improve efficiency of bus traffic. It samples write data going to the destined register module 50 and memory module 52 and provides byte steering for dynamic bus sizing and endianness of CPU data. It also may be used to decode byte enables to SRAM/register during both read and write cycles. In addition to receiving control signals C and address signals D, the write bus buffer 56 also sends read data selection signals E to the local bus multiplexer 58 and register/memory module's address, write data, and byte enable signals F to the memory module 52.

The local bus multiplexer 58 is responsible for all CPU read access data. Memory read data may be received directly from display SRAM memory and it may be validated for less than two MClks. Therefore, in this embodiment memory read data is latched to guarantee hold time for CPU buses. For register read access, read data is returned from the register module 50. As shown, in addition to receiving read data selection signals E from the write bus buffer 56, the local bus multiplexer 58 also receives register/memory module's read data signals G and sends output signals H to the CPU 30 data bus for read cycles.

The LCD display 32 includes an interface that may receive LCD interface signals I from the register module 50. The interface may also send and receive display memory and read data requests and acknowledge signals J to and from the memory module 52. Finally, the interface may receive display memory read data signals K from the memory module 52.

After the initial programming, the following rules are used to implement further the indirect interface LCD controller 40:

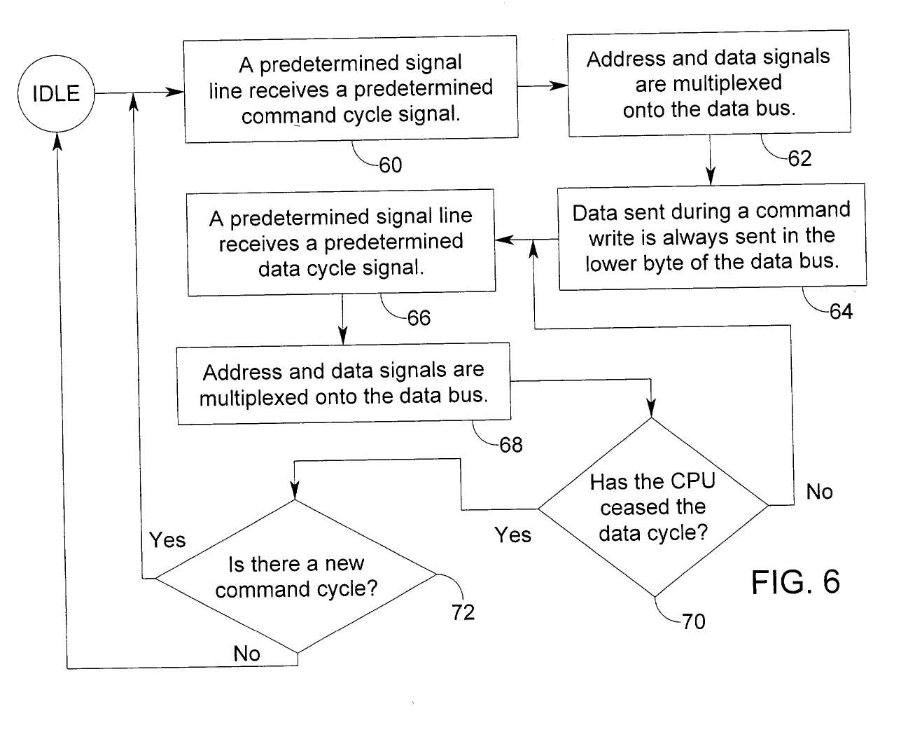

FIG. 6 is a partial simplified operational flow chart of the indirect interface LCD controller 40 of the present invention implementing predetermined rules. For exemplary purposes, the address and data signals applied to the indirect interface LCD controller 40 are multiplexed onto the data bus so that a single set of pins can be used as both address pins and data/line pins. Further, for exemplary purposes, the CPU 30 provides one command cycle and at least one a data cycle for each access. To distinguish between command and data cycles, a predetermined signal line (shown as A0(InMXR)) receives a predetermined signal (e.g. low for command cycle and high for data cycle). A command cycle is always sent first followed by a data cycle. Data sent during a command write is always sent in the lower byte (i.e. 8 bits) in the data bus (e.g. D[7:0]).

For exemplary purposes, FIG. 6 begins in an IDLE state. Then, when a predetermined signal line receives a predetermined command cycle signal 60, address and data signals are multiplexed onto the data bus 62. It should be noted that data sent during a command write is always sent in a predetermined byte of the data bus 64. Then, when a predetermined signal line receives a predetermined data cycle signal 66, address and data signals are multiplexed onto the data bus 68. If the predetermined signal line continues to receive the predetermined data cycle signals, address and data signals continue multiplexed onto the data bus 68 in the Burst Mode with Auto Increment of Memory. When the CPU ceases the data cycle 70, the indirect interface LCD controller 40 determines whether there is a new command cycle 72. It should be noted that steps 70 and 72 may be coexistent with steps 60 and 66 in that the receipt of either a command data signal or a data cycle signal received on the predetermined signal line would effectively determine whether the CPU ceased the data cycle or whether there is a new command cycle.

It should be noted that alternative rules could be implemented without affecting the scope of the invention. For example, to distinguish between command and data cycles, the predetermined signal line A0(InMXR) may receive a high signal for command cycle and low for data cycle. A data cycle is always sent first followed by a command cycle. Still further, data sent during a command write could be sent in the upper byte (i.e. 8 bits) in the data bus (e.g. D[15:8]).

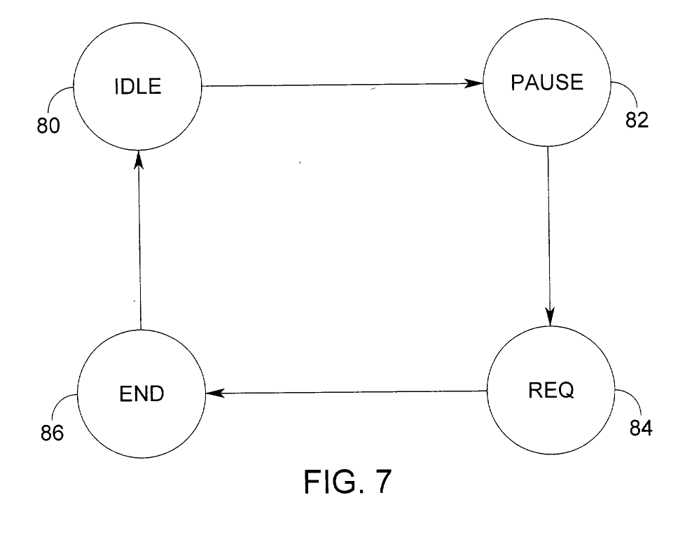

FIG. 7 shows an exemplary state machine for the indirect interface LCD controller 40. In this embodiment, there are only four states: IDLE 80, PAUSE 82, REQ 84, and END 86. The indirect interface LCD controller 40 stays in IDLE 80 until Start (the Memory Access Select bit that is shown as A0 or Read) is sampled high. Then the indirect interface LCD controller 40 goes to PAUSE 82. Start is sampled at the rising edge of the A0 or Read signal during the data cycle, but not the command cycle. A request will be generated during the PAUSE 82 state when the previous request is acknowledged as being serviced. When the request is sent, the indirect interface LCD controller 40 will go to the REQ 84 state where it will wait for read data (in the read cycle) or write data is sampled at the write bus buffer 56 (in the write cycle). For the read cycle, the indirect interface LCD controller 40 will stay at REQ 84 until the read data is ready on the data bus. When ready, the indirect interface LCD controller 40 will go to the END 86 state, and then return to IDLE 80. For the write cycle the indirect interface LCD controller 40 will stay at REQ 84 for 1 clock for the write bus buffer 56, go to the END 86 state, and then return to IDLE 80. In this preferred embodiment, the indirect interface LCD controller 40 has no WAIT#/READY signal so it is necessary to ensure that the write bus buffer 56 is cleared (access request is acknowledged) before the next write transfer takes place. In an alternative embodiment, a WAIT#/READY line may be added to signal a completion for the CPU.

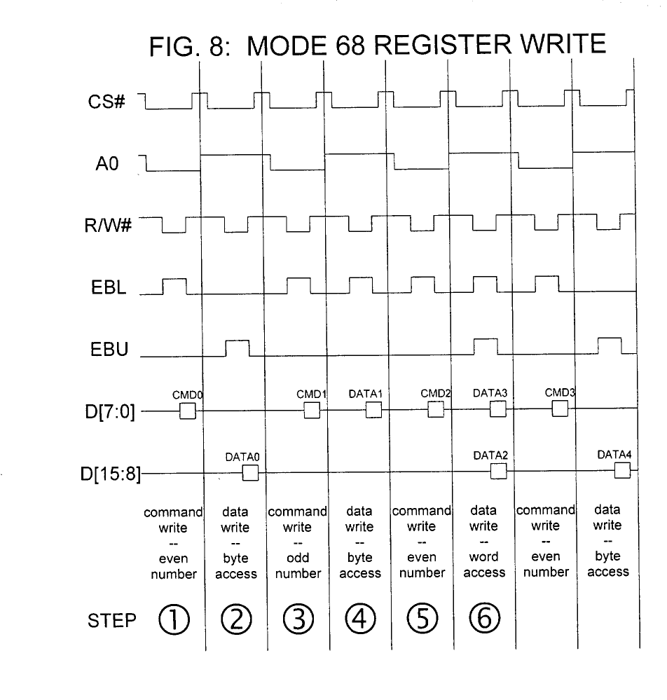

As shown in the exemplary timing diagrams of FIGS. 8 to 19, and discussed in connection therewith, the indirect interface LCD controller 40 has different address and control signal timing than other CPU buses. To implement this timing, latches may be used to sample access addresses. Further, memory/register access select may be decoded during the command cycle. Because the data bus generally does not hold the access address during the data cycle, the address latch holds the access address value until the next command cycle. Similarly, the command for the current cycle is not known until its data cycle and, thus, command, byte lane, and write data (during the write cycle) signals will be latched at the start of the data cycle. The command, byte lane, and write data signals are held until the next data cycle.

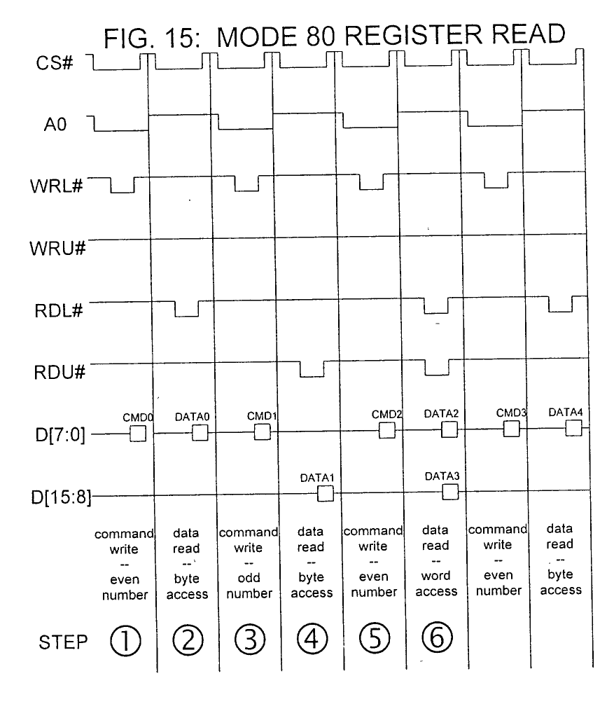

FIGS. 8 to 19 are exemplary timing diagrams of preferred embodiments of the present invention. FIGS. 8 to 14 are directed to a preferred embodiment in Mode 68. FIGS. 15 to 19 are directed to a preferred embodiment in Mode 80.

Turning first to FIG. 8, this timing diagram shows the timing of a “register write” in Mode 68. In this diagram, the data at step 6 is transmitted as big endian (e.g. the data input on D[7:0] is DATA3 and the data input on D[15:8] is DATA2), but the embodiment could be modified to be little endian (e.g. the data input on D[7:0] is DATA2 and the data input on D[15:8] is DATA3). The exemplary steps for a register write according to this embodiment are as follows:

STEP 1: write register address (command write).

STEP 2: write register data (data write). The even numbered register uses the high byte.

STEP 3: write register address (command write).

STEP 4: write register data (data write). This step demonstrates how this embodiment accesses an odd numbered register using the low byte. It should be noted that the high byte could also have been used by asserting EBU instead of EBL.

STEP 5: write register address (command write).

STEP 6: write register data (data write). Word accesses (16-bit) use the higher byte for the even register address and the lower byte for the odd register address.

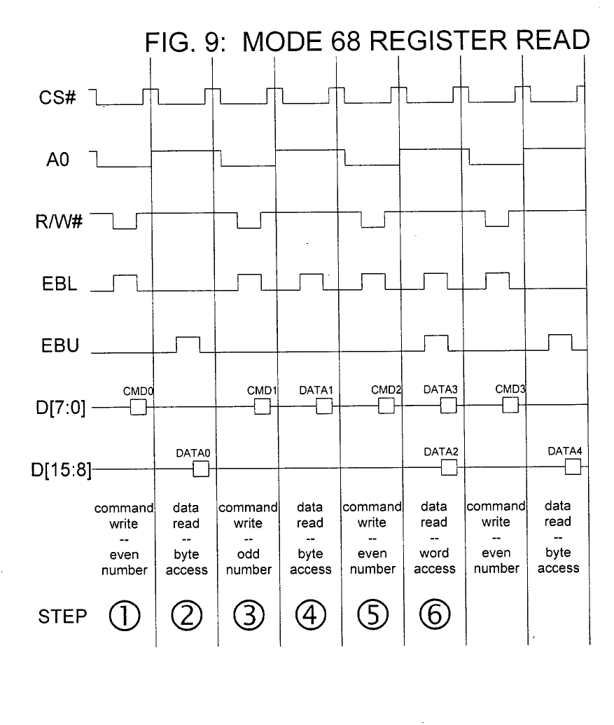

FIG. 9 shows the timing of a “register read” in Mode 68. As mentioned for FIG. 8, in this diagram, the data is transmitted as big endian, but the embodiment could be modified to be little endian. The exemplary steps for a register read according to this embodiment are as follows:

STEP 1: write register address (command write).

STEP 2: read register data (data read).

STEP 3: write register address (command write).

STEP 4: read register data (data read). This step demonstrates how this embodiment accesses an odd numbered register using the low byte. It should be noted that the high byte could also have been used by asserting EBU instead of EBL.

STEP 5: write register address (command write)

STEP 6: read register data (data read). Word accesses (16-bit) use the higher byte for the even register address and the lower byte for the odd register address.

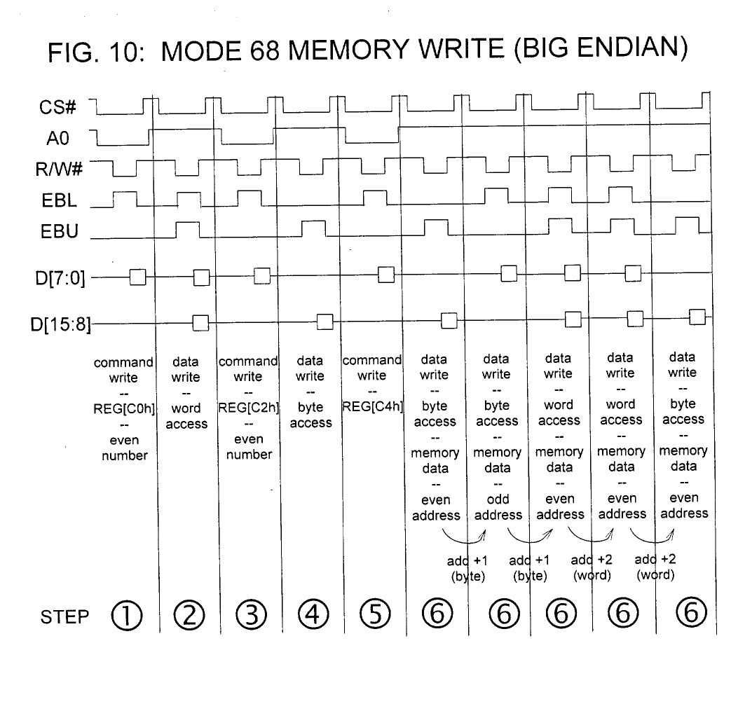

FIG. 10 shows the timing of a “memory write” in Mode 68. As mentioned for the previous figures, in this diagram, the data is shown as being transmitted as big endian, but the embodiment could be modified to be little endian. The exemplary steps for a memory write according to this embodiment are as follows:

STEP 1: write register address of Memory Access Pointer 0 (REG[C0h]) (command write).

STEP 2: write memory address[7:0] to the low byte and memory address[15:8] to the high byte (data write). This places data into RegC0 and RegC1, which form bits [7:0] and [15:8] of memory address respectfully.

STEP 3: write register address of Memory Access Pointer 2 (REG[C2h] bit 0) (command write).

STEP 4: write Memory Access Pointer 2 (REG[c2h] bit 0) (data write). This forms bit 16 of the memory address.

STEP 5: write register number of Memory Access Start register (REG[C4h] (command write). It should be noted that no “data write” is required after a command write to the Memory Access Start register (REG[C4h]). This step configures the exemplary embodiment of the indirect interface LCD controller 40 of the present invention for burst memory access beginning with the next data write.

STEP 6: write Memory data (data write). The exemplary embodiment of the indirect interface LCD controller 40 implements an auto increment function to allow burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”.

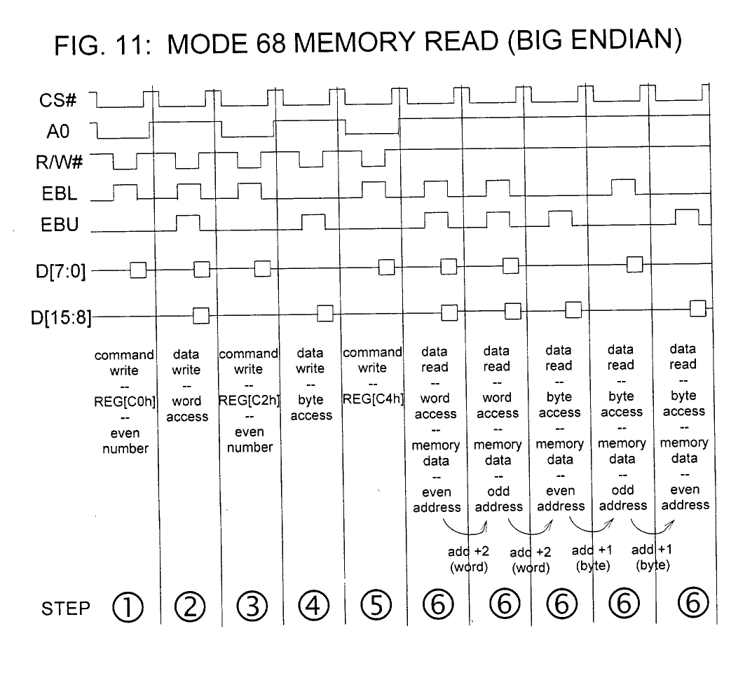

FIG. 11 shows the timing of a “memory read” in Mode 68. As mentioned for the previous figures, in this diagram, the data is shown as being transmitted as big endian, but the embodiment could be modified to be little endian. The exemplary steps for a memory read according to this embodiment are as follows:

STEP 1: write register address of Memory Access Pointer 0 (REG[C0h]) (command write).

STEP 2: write memory address[7:0] to the low byte and memory address[15:8] to the high byte (data write). This places data into RegC0 and RegC1, which forms bits [7:0] and [15:8] of memory address respectfully.

STEP 3: write register address of Memory Access Pointer 2 (REG[C2h] bit 0) (command write).

STEP 4: write Memory Access Pointer (REG[c2h] bit 0) (data write). This forms bit 16 of memory address.

STEP 5: write register number of Memory Access Start register (REG[C4h] (command write). It should be noted that no “data write” is required after a command write to the Memory Access Start register (REG[C4h]). This step configures the exemplary embodiment of the indirect interface LCD controller 40 of the present invention for burst memory access beginning with the next data write.

STEP 6: read Memory data (data read). The exemplary embodiment of the indirect interface LCD controller 40 implements an auto increment function to allow burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”.

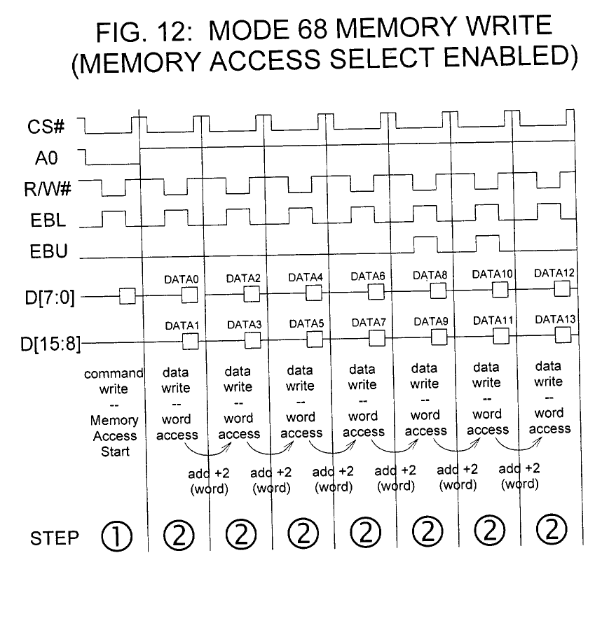

FIG. 12 shows the timing of a “memory write” in Mode 68 when the Memory Access Select bit is enabled (REG[C6h] bit 0=1). In this diagram, the data is shown as being transmitted as little endian (e.g. the data input on D[7:0] is DATAn and the data input on D[15:8] is DATAn+1), but the embodiment could be modified to be big endian (e.g. the data input on D[7:0] is DATAn+1 and the data input on D[15:8] is DATAn). The exemplary steps for a memory write according to this embodiment are as follows:

STEP 1: write register number of Memory Access Start register (REG[C4h]) (command write). It should be noted that no “data write” is required after a command write to the Memory Access Start register (REG[C4h]). This step configures the exemplary embodiment of the indirect interface LCD controller 40 of the present invention for burst memory access beginning with the next data write.

STEP 2: write Memory data (data write). If the Memory Access Select bit (REG[C6h] bit 0=1), memory accesses are word accesses even if EBU is high (EBU is ignored and EBL is used to write both the upper and lower bytes). The big/little endian setting is used to determine the data arrangement for word accesses only.

It should be noted that in this exemplary embodiment of the indirect interface LCD controller 40 an auto increment function allows burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”. It should also be noted that if the Memory Access Select bit is enabled (REG[C6h] bit 0=1), all memory accesses are word accesses. (EBU is ignored). Therefore, the memory address set in REG[C0h] through REG[C2h] must, for this embodiment, be an even address.

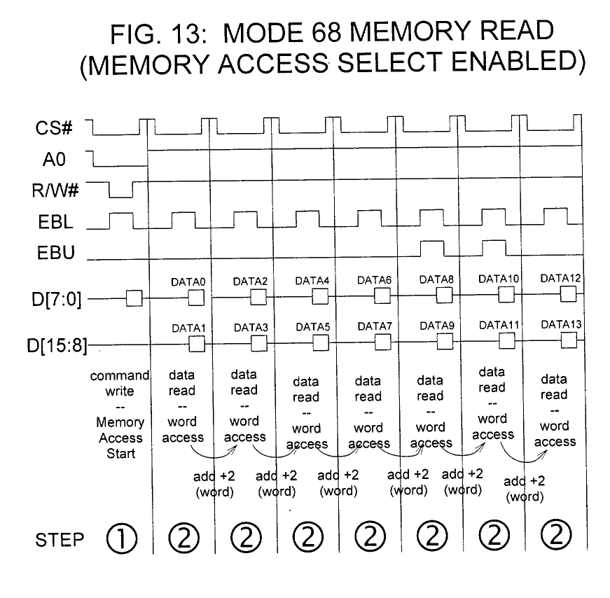

FIG. 13 shows the timing of a “memory read” in Mode 68 when the Memory Access Select bit is enabled (REG[C6h] bit 0=1). In this diagram, as in the previous diagram, the data is shown as being transmitted as little endian, but the embodiment could be modified to be big endian. The exemplary steps for a memory read according to this embodiment are as follows:

STEP 1: write register number of Memory Access Start register (REG[C4h]) (command write). It should be noted that no “data write” is required after a command write to the Memory Access Start register (REG[C4h]). This step configures the exemplary embodiment of the indirect interface LCD controller 40 of the present invention for burst memory access beginning with the next data read.

STEP 2: read Memory data (data read). If the Memory Access Select bit (REG[C6h] bit 0=1), memory accesses are word accesses even if EBU is high (EBU is ignored and EBL is used to write both the upper and lower bytes). The big/little endian setting is used to determine the data arrangement for word accesses only.

The exemplary embodiment of the indirect interface LCD controller 40 implements an auto increment function to allow burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”. It should be noted that if the Memory Access Select bit is enabled (REG[C6h] bit 0=1), all memory accesses are word accesses. (EBU is ignored). Therefore, the memory address set in REG[C0h] through REG[C2h] must, for this embodiment, be an even address. Register access still uses EBU irrespective of REG[C6] bit 0 value.

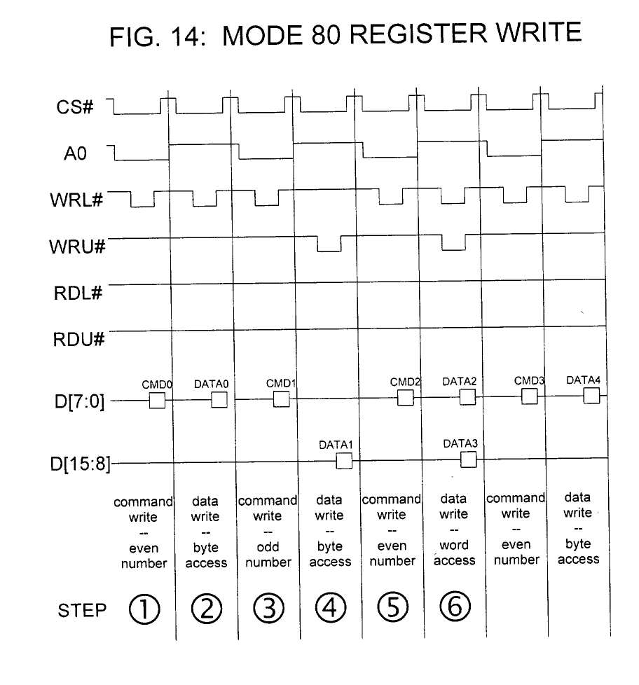

FIG. 14 shows a timing diagram that shows the timing of a “register write” in Mode 80. Mode 80 supports byte and word access for both register and memory access. It also allows both big and little endian modes. In this diagram, the data at step 6 is transmitted as little endian (e.g. the data input on D[7:0] is DATA2 and the data input on D[15:8] is DATA3), but the embodiment could be modified to be big endian (e.g. the data input on D[7:0] is DATA3 and the data input on D[15:8] is DATA2). The exemplary steps for a register write according to this embodiment are as follows:

STEP 1: write register address (command write). Command write is always, in this embodiment, the lower byte.

STEP 2: write register data (data write). Even numbered register uses the low byte.

STEP 3: write register address (command write).

STEP 4: write register data (data write). This step demonstrates how this embodiment accesses an odd numbered register using the low byte. It should be noted that the high byte could also have been used by asserting WRL# instead of WRU#.

STEP 5: write register address (command write)

STEP 6: write register data (data write). Word accesses (16-bit) use the lower byte for the lower register number and the higher byte for the higher register number.

FIG. 15 shows the timing of a “register read” in Mode 80. As mentioned for FIG. 14, in this diagram, the data is transmitted as little endian, but the embodiment could be modified to be big endian. The exemplary steps for a register read according to this embodiment are as follows:

STEP 1: write register address (command write). Command write is always, in this embodiment, the lower byte.

STEP 2: read register data (data read). Even numbered registers use the lower byte.

STEP 3: write register address (command write).

STEP 4: read register data (data read). This step demonstrates how this embodiment accesses an odd numbered register using the low byte. It should be noted that the high byte could also have been used by asserting WRL# instead of WRU#.

STEP 5: write register address (command write).

STEP 6: read register data (data read). Word accesses (16-bit) use the lower byte for the lower register number and the higher byte for the higher register number.

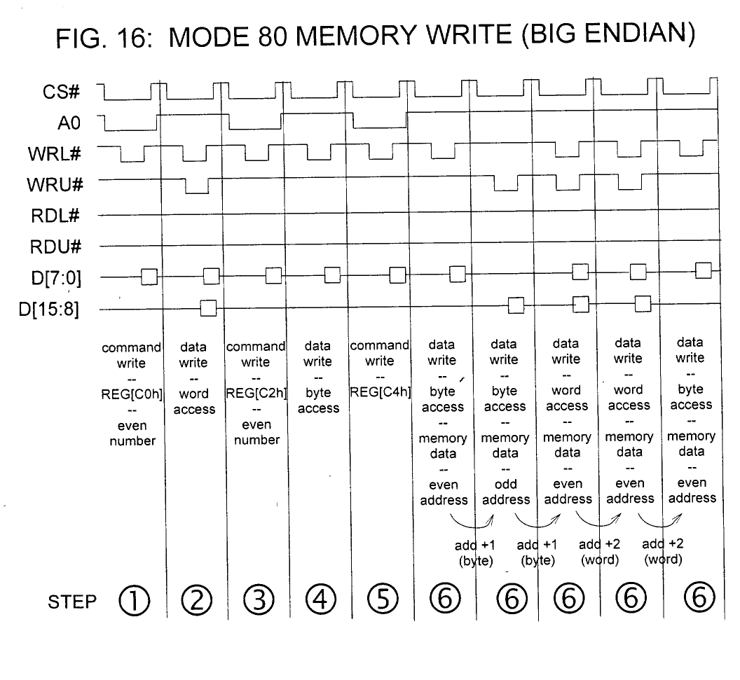

FIG. 16 shows the timing of a “memory write” in Mode 80. The data at step 6 in this diagram is shown as being transmitted as little endian, but the embodiment could be modified to be big endian. The exemplary steps for a memory write according to this embodiment are as follows:

STEP 1: write register address of Memory Access Pointer 0 (REG[C0h]) (command write).

STEP 2: write memory address 0 to the high byte and memory address 1 to the low byte (MA[15:0]) (data write).

STEP 3: write register number of Memory Access Pointer 2 (REG[C2h]) (command write).

STEP 4: write memory address 2 (MA16) to the low byte (data write).

STEP 5: write register number of Memory Access Start register (REG[C4h]) (command write). It should be noted that no “data write” is required after a command write to the Memory Access Start register (REG[C4h]). This step configures the exemplary embodiment of the indirect interface LCD controller 40 of the present invention for burst memory access beginning with the next data write.

STEP 6: write Memory data (data write). The exemplary embodiment of the indirect interface LCD controller 40 implements an auto increment function to allow burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”.

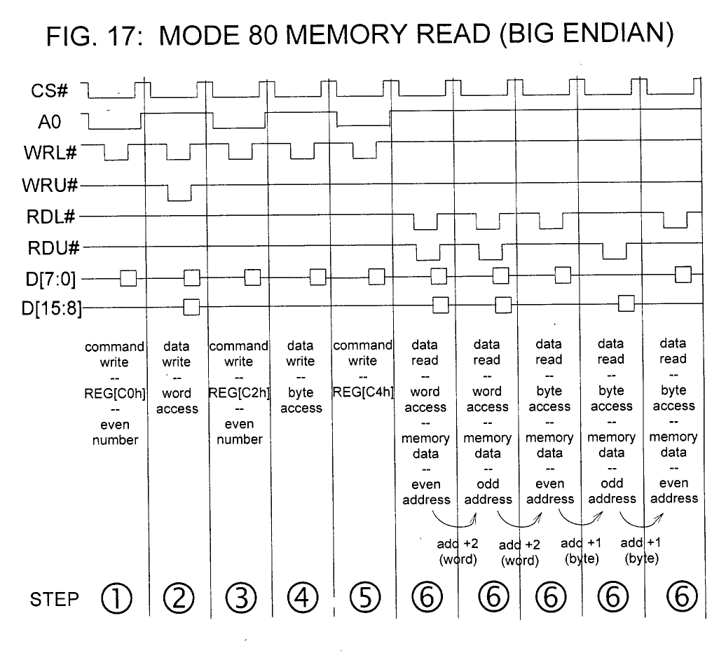

FIG. 17 shows the timing of a “memory read” in Mode 80. In this diagram, the data is shown as being transmitted as little endian, but the embodiment could be modified to be big endian. The exemplary steps for a memory read according to this embodiment are as follows:

STEP 1: write register address of Memory Access Pointer 0 (REG[C0h]) (command write).

STEP 2: write memory address 0 to the high byte and memory address 1 to the low byte (MA[15:0]) (data write).

STEP 3: write register number of Memory Access Pointer 2 (REG[C2h]) (command write).

STEP 4: write memory address 2 (MA16) to the low byte (data write).

STEP 5: write register number of Memory Access Start register (REG[C4h]) (command write). It should be noted that no “data write” is required after a command write to the Memory Access Start register (REG[C4h]). This step configures the exemplary embodiment of the indirect interface LCD controller 40 of the present invention for burst memory access beginning with the next data write.

STEP 6: read Memory data (data read). The exemplary embodiment of the indirect interface LCD controller 40 implements an auto increment function to allow burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”.

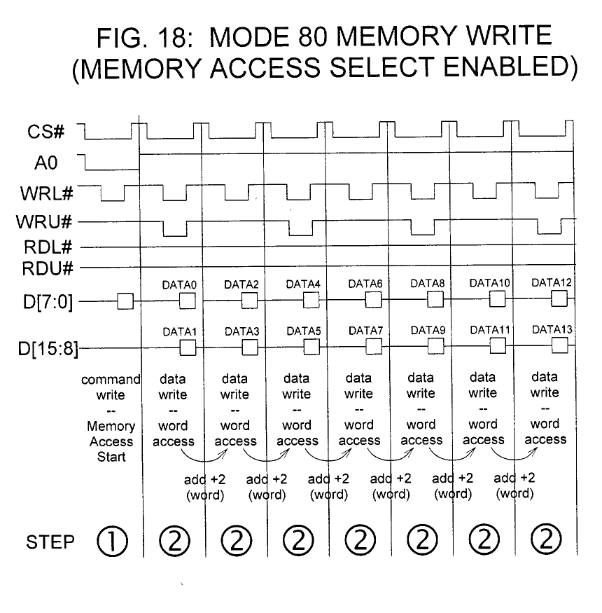

FIG. 18 shows the timing of a “memory write” in Mode 80 when the Memory Access Select bit is enabled (REG[C6h] bit 0=1). In this diagram, the data is shown as being transmitted as little endian (e.g. the data input on D[7:0] is DATAn and the data input on D[15:8] is DATAn+1), but the embodiment could be modified to be big endian (e.g. the data input on D[7:0] is DATAn+1 and the data input on D[15:8] is DATAn). The exemplary steps for a memory write according to this embodiment are as follows:

STEP 1: write register number of Memory Access Start register (REG[C4h]) (command write). It should be noted that no “data write” is required after a command write to the Memory Access Start register (REG[C4h]). This step configures the exemplary embodiment of the indirect interface LCD controller 40 of the present invention for burst memory access beginning with the next data write.

STEP 2: write Memory data (data write). If the Memory Access Select bit (REG[C6h] bit 0=1), memory accesses are word accesses even if WRU# is high (WRU# is ignored and WRL# is used to write both the upper and lower bytes). The big/Little endian setting is used to determine the data arrangement for word accesses only.

The exemplary embodiment of the indirect interface LCD controller 40 implements an auto increment function to allow burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”. It should be noted that if the Memory Access Select bit is enabled (REG[C6h] bit 0=1), all memory accesses are word accesses. (WRU# is ignored). Therefore, the memory address set in REG[C0h] through REG[C2h] must, for this embodiment, be an even address.

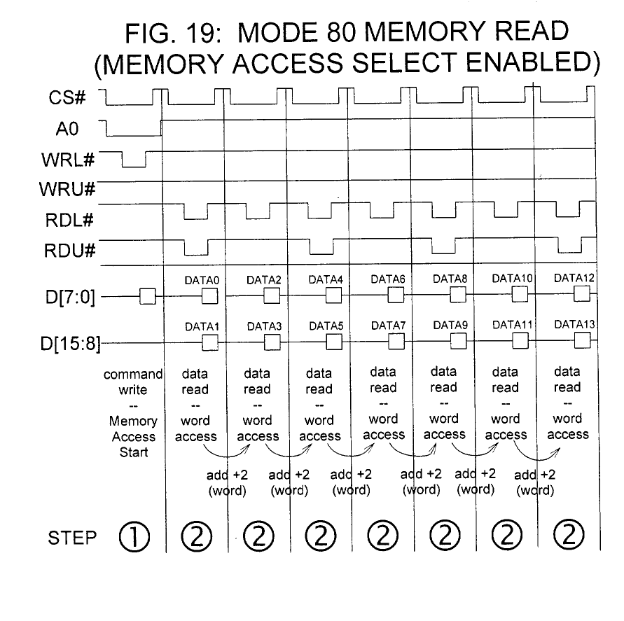

FIG. 19 shows the timing of a “memory read” in Mode 80 when the Memory Access Select bit is enabled (REG[C6h] bit 0=1). In this diagram, as in the previous diagram, the data is shown as being transmitted as little endian, but the embodiment could be modified to be big endian. The exemplary steps for a memory read according to this embodiment are as follows:

STEP 1: write register number of Memory Access Start register (REG[C4h]) (command write).). It should be noted that no “data write” is required after a command write to the Memory Access Start register (REG[C4h]). This step configures the exemplary embodiment of the indirect interface LCD controller 40 of the present invention for burst memory access beginning with the next data read.

STEP 2: read Memory data (data write). If the Memory Access Select bit (REG[C6h] bit 0=1), memory accesses are word accesses even if RDU# is high (RDU# is ignored and RDL# is used to write both the upper and lower bytes). The big/Little endian setting is used to determine the data arrangement for word accesses only.

The exemplary embodiment of the indirect interface LCD controller 40 implements an auto increment function to allow burst memory accesses. For byte accesses, the Memory Address Pointer registers (REG[C0h], REG[C1h], REG[C2h]) are automatically incremented “+1”. For word accesses, the Memory Address Pointer registers are automatically incremented “+2”. If the Memory Access Select bit is enabled (REG[C6h] bit 0=1), all memory accesses are word accesses. (RDU# is ignored). Therefore, the memory address set in REG[C0h] through REG[C2h] must, for this embodiment, be an even address.

The present invention may be incorporated into any device in which a display device is desired. Although discussed in terms of an LCD DISPLAY 32, the present invention may be used with other display types that use electricity to control the display. For example, the present invention may be used in displays such as CRT displays, plasma displays, TVs, LVDS displays, and LCD displays.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. An indirect interface chip having a reduced number of lines/pins, said indirect interface chip for use with an external system, said external system including an external processing device and an external display device, said indirect interface chip comprising:
(a) a processor interface for transferring signals between said indirect interface chip and said external processing device;
(b) a display interface for transferring signals between said indirect interface chip and said external display device;
(c) said signals being transferred between said indirect interface chip and said external processing device being transferred using a command cycle followed by at least one data cycle;
(d) said signals further comprising address signals, data signals, and command/data determination signals;
(e) said processor interface further comprising:
(i) an address/data bus, both said address signals and said data signals being transferred over said address/data bus;
(ii) a command/data determination line/pin, said command/data determination signals being transferred over said command/data determination line/pin to distinguish between said command cycle and said data cycle.

2. The indirect interface chip of claim 1 further comprising:
(a) a register module functionally interposed between said indirect interface system and said external display device; and
(b) a memory module functionally interposed between said indirect interface system and said external display device.

3. The indirect interface chip of claim 2 wherein said register module and said memory module are independent modules.

4. The indirect interface chip of claim 2 wherein said register module and said memory module are incorporated into said indirect interface chip.

5. The indirect interface chip of claim 2 wherein said register module and said memory module are incorporated into said external processing device.

6. The indirect interface chip of claim 2 wherein said register module and said memory module are incorporated into said external display device

7. The indirect interface chip of claim 1, said address/data bus having a maximum of sixteen (16) data lines/pins and a maximum of five (5) control signals.

8. The indirect interface chip of claim 7, said address/data bus having sixteen (16) data lines/pins for transmitting an upper byte of data and a lower byte of data, wherein a one byte command write signal transmitted over said address/data bus is always transmitted as an upper byte of data.

9. The indirect interface chip of claim 7, said address/data bus having sixteen (16) data lines/pins for transmitting an upper byte of data and a lower byte of data, wherein a one byte command write signal transmitted over said address/data bus is always transmitted as a predetermined byte of data.

10. The indirect interface chip of claim 1, said address/data bus having a maximum of eight (8) data lines/pins and a maximum of four (4) control signals.

11. The indirect interface chip of claim 1, said indirect interface chip having a plurality of modes of operation.

12. The indirect interface chip of claim 1, said indirect interface chip supporting both little endian and big endian data input.

13. The indirect interface chip of claim 1, said indirect interface chip having an asynchronous design.

14. The indirect interface chip of claim 1, said indirect interface having a Burst Mode with Auto Increment of Memory address.

15. An indirect interface method that reduces the number of lines/pins necessary to communicate between a processing device and a display device, said indirect interface method comprising the steps of:
(a) providing an indirect interface having an address/data bus;
(b) transferring signals between said indirect interface and said processing device by:
(i) transferring signals between said indirect interface and said processing device using a command cycle followed by at least one data cycle; and
(iii) transferring both address signals and data signals over said address/data bus; and
(c) transferring signals between said indirect interface and said display device.

16. The indirect interface method of claim 15 further comprising the step of transferring command/data determination signals over at least one command/data determination line/pin of said indirect interface to distinguish between said command cycle and said data cycle.

17. The indirect interface method of claim 15, said address/data bus having an upper byte and a lower byte, said indirect interface method further comprising the step of always transferring a one byte command write signal over a predetermined one of said upper byte and said lower byte of said address/data bus.

18. An indirect interface method for communicating between a processing device and a display device, said indirect interface method comprising the steps of:
(a) providing an indirect interface display controller having an address/data bus and a predetermined cycle signal line;
(b) receiving address signals and data signals for each access from said processing device in a command cycle followed by at least one a data cycle;
(c) in a command cycle:
(i) receiving a predetermined command cycle signal on said predetermined cycle signal line to begin a command cycle; and
(ii) receiving multiplexed address signals and data signals on said address/data bus; and
(d) in a data cycle:
(i) receiving a predetermined data cycle signal on said predetermined cycle signal line to begin a data cycle; and
(ii) receiving multiplexed address signals and data signals on said address/data bus.

19. The indirect interface method of claim 18 further comprising the steps of:
(a) receiving a plurality predetermined data cycle signals on said predetermined cycle signal line; and
(b) repeating step (d) of claim 18.

20. The indirect interface method of claim 18 further comprising the step of receiving data signals during a command write on a predetermined data portion of said address/data bus.

21. A system comprising:
(a) an indirect interface display controller;
(b) a processing device;
(c) a display device;
(d) a processor interface for transferring signals between said indirect interface display controller and said processing device;
(e) a display interface for transferring signals between said indirect interface display controller and said display device;
(f) said signals further comprising address signals and data signals;
(g) said processor interface further comprising an address/data bus, both said address signals and said data signals being transferred over said address/data bus; and
(h) said indirect interface display controller reducing the number of lines/pins necessary for connections.

22. The system of claim 21, wherein said signals being transferred between said indirect interface display controller and said external processing device are transferred using a command cycle followed by at least one data cycle.

23. The system of claim 21, said signals further comprising command/data determination signals, said processor interface means further comprising a command/data determination line/pin, said command/data determination signals being transferred over said command/data determination line/pin to distinguish between said command cycle and said data cycle.

24. The system of claim 21, said address/data bus having a maximum of sixteen (16) data lines/pins and a maximum of five (5) control signals.

25. The system of claim 24, said address/data bus having sixteen (16) data lines/pins for transmitting an upper byte of data and a lower byte of data, wherein a one byte command write signal transmitted over said address/data bus is always transmitted as an upper byte of data.

26. The system of claim 24, said address/data bus having sixteen (16) data lines/pins for transmitting an upper byte of data and a lower byte of data, wherein a one byte command write signal transmitted over said address/data bus is always transmitted as a predetermined byte of data.

27. The system of claim 21, said address/data bus having a maximum of eight (8) data lines/pins and a maximum of four (4) control signals.

28. An indirect interface system for use with an external system, wherein said external system includes at least one processing device and at least one display device, said indirect interface system comprising:
(a) processor interface means for transferring signals between said indirect interface system and said external processing device;
(b) display interface means for transferring signals between said indirect interface system and said external display device;
(c) said signals comprising address signals and data signals;
(d) said processor interface means further comprising an address/data bus, both said address signals and said data signals being transferred over said address/data bus; and
(e) said indirect interface system reducing the number of lines/pins necessary for connections.

29. The indirect interface system of claim 28, wherein said signals being transferred between said indirect interface system and said external processing device are transferred using a command cycle followed by at least one data cycle.

30. The indirect interface system of claim 28, said signals further comprising command/data determination signals, said processor interface means further comprising a command/data determination line/pin, said command/data determination signals being transferred over said command/data determination line/pin to distinguish between said command cycle and said data cycle.

31. The indirect interface system of claim 28, said address/data bus having a maximum of sixteen (16) data lines/pins and a maximum of five (5) control signals.

32. The indirect interface system of claim 31, said address/data bus having sixteen (16) data lines/pins for transmitting an upper byte of data and a lower byte of data, wherein a one byte command write signal transmitted over said address/data bus is always transmitted as an upper byte of data.

33. The indirect interface system of claim 31, said address/data bus having sixteen (16) data lines/pins for transmitting an upper byte of data and a lower byte of data, wherein a one byte command write signal transmitted over said address/data bus is always transmitted as a predetermined byte of data.

34. The indirect interface system of claim 28, said address/data bus having a maximum of eight (8) data lines/pins and a maximum of four (4) control signals.

35. A state machine for mediating the transmission of signals between a processor and an indirect interface, said state machine comprising a logic circuit that, at any one time, operates in one of a plurality of states including:
(a) an idle state wherein said indirect interface awaits receipt of a memory access command;
(b) a pause state representing a state transition from said idle state that occurs in response to said processor having issued said memory access command, said pause state wherein said indirect interface awaits receipt of a request command;
(c) a request state representing a state transition from said pause state that occurs in response to said processor having issued said request command, said request state wherein said indirect interface processes said request command; and
(d) an end state representing a state transition from said request state that occurs when said indirect interface has processed said request command.

36. The state machine of claim 35, wherein said state machine returns to said idle state after said end state.

37. The state machine of claim 35, wherein said request command is generated during the pause state when the previous request command is acknowledged as being serviced.

38. The state machine of claim 35, said request state wherein said indirect interface waits for read data during a read cycle.

39. The state machine of claim 35, said request state wherein said indirect interface samples the write buffer during a write cycle.
